(19) United States
(12) Patent Application Publication
(10) Pub. No.: US 2016/0269381 A1
(43) Pub. Date: Sep. 15, 2016

(54) APPARATUS, SYSTEM AND METHOD OF DYNAMICALLY CONTROLLING ACCESS TO A CLOUD SERVICE

(71) Applicant: Synchronoss Technologies, Inc., Bridgewater, NJ (US)

(72) Inventor: Sumeet S. Paul, Evanston, IL (US)

(73) Assignee: Synchronoss Technologies, Inc., Bridgewater, NJ (US)

(21) Appl. No.: 15/046,287

(22) Filed: Feb. 17, 2016

Related U.S. Application Data
(60) Provisional application No. 62/131,042, filed on Mar. 10, 2015.

(51) Int. Cl. H04L 29/06; H04B 1/3816; H04L 29/08

(52) U.S. Cl. CPC H04L 63/08; H04L 67/10; H04L 67/306; H04B 1/3816; H04L 63/102

(57) ABSTRACT

Embodiments of the present invention are directed to multiple-factor authentication for accessing a cloud service from end-user devices. Authentication can be account-based, carrier-based or a combination thereof. Upon a first activation of a client application on an end-user device, the application first takes the user through a multiple-factor authentication process. Thereafter, upon each subsequent activation of the client application, the client application automatically obtains an identifier from the device and provides at least the obtained identifier to a server providing the cloud service. The server determines whether the identifier matches one of previously stored identifiers in the user's account. A previously stored identifier can be a unique device identifier of an “allowed” device or can be a carrier supplied identifier of a user. Based on the determination, the server automatically allows the device access to the cloud service without other user input.

### RELATED APPLICATIONS

This application claims benefit of priority under 35 U.S.C. section 119(e) of the co-pending U.S. Provisional Patent Application Ser. No. 62/131,042, filed Mar. 10, 2015, entitled “Method for Dynamic Restriction of Access to Cloud Based Content by End User Terminal,” which is hereby incorporated by reference in its entirety.

### FIELD OF INVENTION

The present invention relates to access control. More particularly, the present invention relates to an apparatus, system and method of dynamically controlling access to a cloud service.

### BACKGROUND OF THE INVENTION

Prior art solutions for accessing cloud data are restricted to a single form authentication, such a username/password based authentication. Although it is easy to remember a limited number of logins to a couple of cloud accounts and may be convenient enough to enter a login from several end-user devices, it becomes difficult to remember the correct login to access a particular cloud account when there too many logins to remember. New solutions for accessing cloud data that assist in authentication are desired.

### BRIEF SUMMARY OF THE INVENTION

Embodiments of the present invention are directed to multiple-factor authentication for accessing a cloud service from end-user devices. Authentication can be account-based, carrier-based or a combination thereof. Upon a first activation of a client application on an end-user device, the application first takes the user through a multiple-factor authentication process. Thereafter, upon each subsequent activation of the client application, the client application automatically obtains an identifier from the device and provides at least the obtained identifier to a server providing the cloud service. The server determines whether the identifier matches one of previously stored identifiers in the user's account. A previously stored identifier can be a unique device identifier of an “allowed” device or can be a carrier supplied identifier of a user. Based on the determination, the server automatically allows the device access to the cloud service without other user input.

In one aspect, a method is provided. The method is of using multiple-factor authentication for accessing a cloud service from end-user devices. The method includes automatically retrieving by an end-user device data from the end-user device, and transmitting by the end-user device the retrieved data to a server. The method also includes determining by the server whether the retrieved data transmitted from the end-user device is associated with an account in the server. The method also includes, based on a determination that the retrieved data is associated with an account in the server, allowing by the server access to its service from the end-user device and, based on a determination that the retrieved data is not associated with any accounts in the server, providing by the end-user device an opportunity to register to thereby create a new account in the server and an opportunity to link either a SIM card or the end-user device to an existing account.

In some embodiments, the step of automatically retrieving by an end-user device data from the end-user device includes detecting by the end-user device whether a SIM card is associated with the end-user device, based on a detection that a SIM card is associated with the end-user device, extracting by the end-user device a carrier-supplied unique user identifier from the SIM card, wherein the retrieved data includes the carrier-supplied unique user identifier and, based on a detection that no SIM card is associated with the end-user device, extracting by the end-user device a unique device identifier of the end-user device, wherein the retrieved data includes the unique device identifier.

In some embodiments, the method also includes transmitting by the end-user device a server-generated token that is stored on the end-user device.

In some embodiments, the step of providing by the end-user device an opportunity to register to thereby create a new account in the server includes receiving by the end-user device registration information and at least one access key that are input by a user, transmitting by the end-user device the retrieved data to the server, establishing by the server the new account, and storing the registration information and the at least one access key in the new account. In some embodiments, the end-user device is indicated as a primary device in the new account.

In some embodiments, the step of providing by the end-user device an opportunity to link either a SIM card or the end-user device to an existing account includes receiving by the end-user device a first user input, wherein the first user input includes at least one access key associated with the existing account, sending by the end-user device the first user input to the server to identify the existing account, generating and sending by the server a code to a primary device that is distinct and separate from the end-user device, receiving by the end-user device a second user input, transmitting by the end-user device the second user input and the retrieved data to the server, comparing by the server the second user input with the code, and, based on a comparison that the second user input matches the code, storing by the server the retrieved data in the existing account. In some embodiments, the code is a one-time authentication code.

In some embodiments, the method also includes, prior to the step of storing by the server the retrieved data in the existing account, generating and sending by the server a token to the end-user device, automatically reading by the end-user device the token received by the end-user device, transmitting by the end-user device the received token to the server, and determining by the server whether the transmitted token is valid.

In another aspect, a system is provided. The system is for using multiple-factor authentication for accessing a cloud service from end-user devices. The system includes a server providing a cloud service and configured to generate a one-time authentication code. The server also includes an end-user device in communication with the server. The end-user device is configured to retrieve by the end-user device data from the primary end-user device, send by the end-user device the retrieved data to the server, access by the end-user the cloud service upon a first determination by the server, create by the end-user device a new account in the server upon a second determination by the server, and update by the end-user device an existing account in the server upon a third determination by the server.

In some embodiments, the end-user device includes a SIM card, and the retrieved data includes a carrier-supplied unique user identifier extracted from the SIM card. Alternatively, the end-user device does not include a SIM card, and the retrieved data includes a unique device identifier of the end-user device.

In some embodiments, the first determination by the server includes a determination that the retrieved data is associated with an account in the server. In some embodiments, the server is also configured to generate a token. In some embodiments, the first determination by the server also includes a determination that a user input on the end-user device matches the token generated by the server.

In some embodiments, the second determination by the server includes a determination that a user of the end-user device does not have an account in the server. In some embodiments, the new account in the server includes the retrieved data.

In some embodiments, the third determination by the server includes a determination that the user of the end-user device is associated with the existing account in the server. In some embodiments, the existing account in the server includes the retrieved data. In some embodiments, the third determination by the server also includes a determination that another user input on the end-user device matches the one-time authentication code generated by the server. In some embodiments, the existing account in the server includes the retrieved data only when there is a match between the another user input and the one-time authentication code.

In yet another aspect, a computing device is provided. The computing device is in communication with a server that provides a cloud service. The computing device includes a processor and an application executed by the processor. The application configured to retrieve data from the primary end-user device and send the retrieved data to the server. The application is also configured to access the cloud service upon a determination by the server that retrieved data is associated with an account in the server. The application is also configured to create a new account in the server with the retrieved data upon a determination by the server that a user of the computing device does not have an account in the server. The application is also configured to update an existing account in the server with the retrieved data upon a determination by the server the user is associated with the existing account in the server.

In some embodiments, the data includes a carrier-supplied unique user identifier extracted from a SIM card that is coupled with the computing device. Alternatively, the data includes a unique device identifier of the computing device.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 illustrates an exemplary system according to some embodiments.

FIG. 2 illustrates a block diagram of an exemplary computing device according to some embodiments.

FIG. 3 illustrates an exemplary method of dynamically controlling access to cloud based content according to some embodiments.

FIG. 4 illustrates an exemplary method of registering with a server in accordance with some embodiments.

FIG. 5 illustrates an exemplary method of updating a user account in accordance with some embodiments

### DETAILED DESCRIPTION OF THE INVENTION

In the following description, numerous details are set forth for purposes of explanation. However, one of ordinary skill in the art will realize that the invention can be practiced without the use of these specific details. Thus, the present invention is not intended to be limited to the embodiments shown but is to be accorded the widest scope consistent with the principles and features described herein.

Embodiments of the present invention are directed to multiple-factor authentication for accessing a cloud service from end-user devices. Authentication can be account-based, carrier-based or a combination thereof. Upon a first activation of a client application on an end-user device, the application first takes the user through a multiple-factor authentication process. Thereafter, upon each subsequent activation of the client application, the client application automatically obtains an identifier from the device and provides at least the obtained identifier to a server providing the cloud service. The server determines whether the identifier matches one of previously stored identifiers in the user's account. A previously stored identifier can be a unique device identifier of an “allowed” device or can be a carrier supplied identifier of a user. Based on the determination, the server automatically allows the device access to the cloud service without other user input.

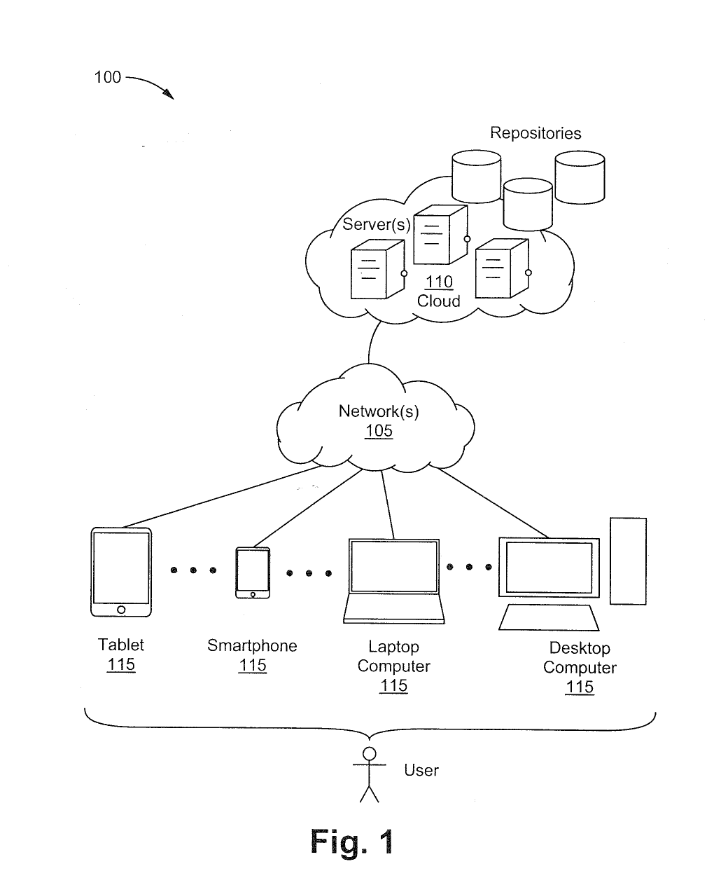

FIG. 1 illustrates an exemplary system 100 according to some embodiments. The system 100 typically includes a network(s) 105, such as the Internet, and a server(s) in a cloud 110. One or more end-user devices 115 are able to communicatively couple with the server via the network 105. Each subscriber has an account in the server in order to access a cloud service(s). An exemplary cloud service is a backup/storage service. The cloud service is accessible from an end-user device 115 via a web browser and/or a client application on the end-user device 115. Assume for purposes of discussion herein that all of the end-user devices 115 belong to a single user (e.g., subscriber) who has an account in the server.

An exemplary end-user device is a tablet, a smart phone, a laptop computer, a desktop computer, or other like. Each end-user device 115 is associated with a unique device identifier, such a phone number or a hardware identifier of the end-user device 115. In some embodiments, an end-user device 115 can be purchased through a carrier, such as AT&T™ cellular provider or Verizon™ cellular provider, and includes a carrier-provided SIM (subscriber identity module) card. A SIM card stores data about a specific user, such as a unique and authenticated user identifier, so that that user can be identified and authenticated to the carrier network. A SIM card can be moved from one end-user device to another end-user device.

Cloud-based content is maintained by the server and is stored in a repository(ies). The repository can be located in the cloud 110, as illustrated in FIG. 1, although the repository can be located elsewhere in the system 100 as long as the repository is accessible by the server. The content can include personal data uploaded by the user from any one of the end-user devices 115. Alternatively or in addition to, the cloud-based content can include private data that is only accessible by subscribers. Alternatively or in addition to, the cloud-based content can include public data that is accessible by the general public (e.g., subscribers and non-subscribers).

The user's account in the server allows the user, for example, to set preferences, to configure account information, such as subscription and billing information, to disable an end-user device (discussed below), and/or the like. The user's account includes identifiers and access keys for authentication to access the cloud service.

An identifier of an end-user device can be automatically retrieved by the client application upon its launch on the end-user device and automatically provided in the user's account, or can be manually entered by the user in the user's account. An identifier can be a unique device identifier of an end-user device that the user implicitly or explicitly authorizes/approves access to cloud service therefrom. An “approved” end-user device is an end-user device that has been identified in the user's account by its unique device identifier. An identifier can also be a carrier-supplied unique identifier of the user (e.g., from a SIM card) such that the user is able to access content from any end-user device so long as the SIM card is in or otherwise associated with that end-user device.

An access key is manually entered by the user in the user's account. Exemplary access keys include, but are not limited to, email address, user account identifier, username, password, phone number, security question, etc. Access keys are a form of authentication to the user's account and the cloud service.

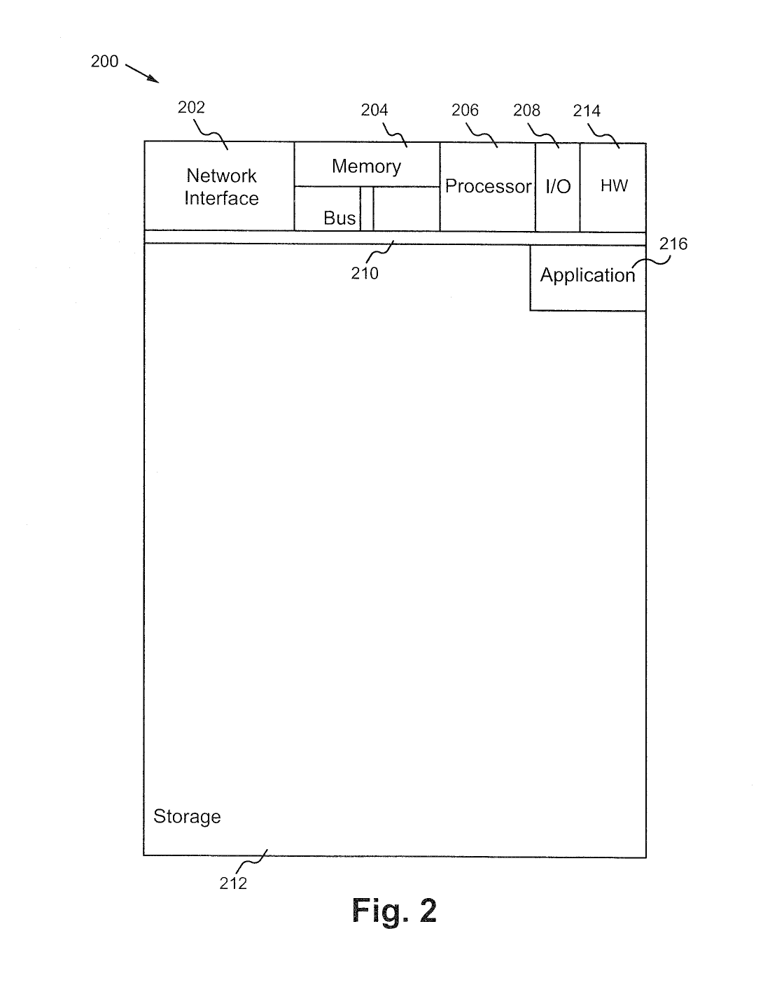

FIG. 2 illustrates a block diagram of an exemplary computing device 200 according to some embodiments. The computing device 200 is able to be used to acquire, cache, store, compute, search, transfer, communicate and/or display information. The server(s) in the cloud 110 and/or the end-user devices 115 of the FIG. 1 can be similarly configured as the computing device 200.

In general, a hardware structure suitable for implementing the computing device 200 includes a network interface 202, a memory 204, processor(s) 206, I/O device(s) 208, a bus 210 and a storage device 212. The choice of processor 206 is not critical as long as a suitable processor with sufficient speed is chosen. In some embodiments, the computing device 200 includes a plurality of processors 206. The memory 204 is able to be any conventional computer memory known in the art. The storage device 212 is able to include a hard drive, CDROM, CDRW, DVD, DVDRW, flash memory card, RAM, ROM, EPROM, EEPROM or any other storage device. The computing device 200 is able to include one or more network interfaces 202. An example of a network interface includes a network card connected to an Ethernet or other type of LAN. The I/O device(s) 208 are able to include one or more of the following: keyboard, mouse, monitor, display, printer, modem, touchscreen, button interface and other devices. Application(s) 214, such as the client application or one or more server-side applications implementing authentication discussed elsewhere, are likely to be stored in the storage device 212 and memory 204 and are processed by the processor 206. More or less components or modules shown in FIG. 2 are able to be included in the computing device 200. For example, the computing device 200 can include an interface module or a locus. As discussed elsewhere, the interface module includes at least one user interface that is accessible by the user to access the cloud service. The locus is for receiving a SIM card.

The computing device 200 can be a server or an end-user device. Exemplary end-user devices include, but are not limited to, a tablet, a mobile phone, a smart phone, a smart watch, a desktop computer, a laptop computer, a netbook, or any suitable computing device such as special purpose devices, including set top boxes and automobile consoles.

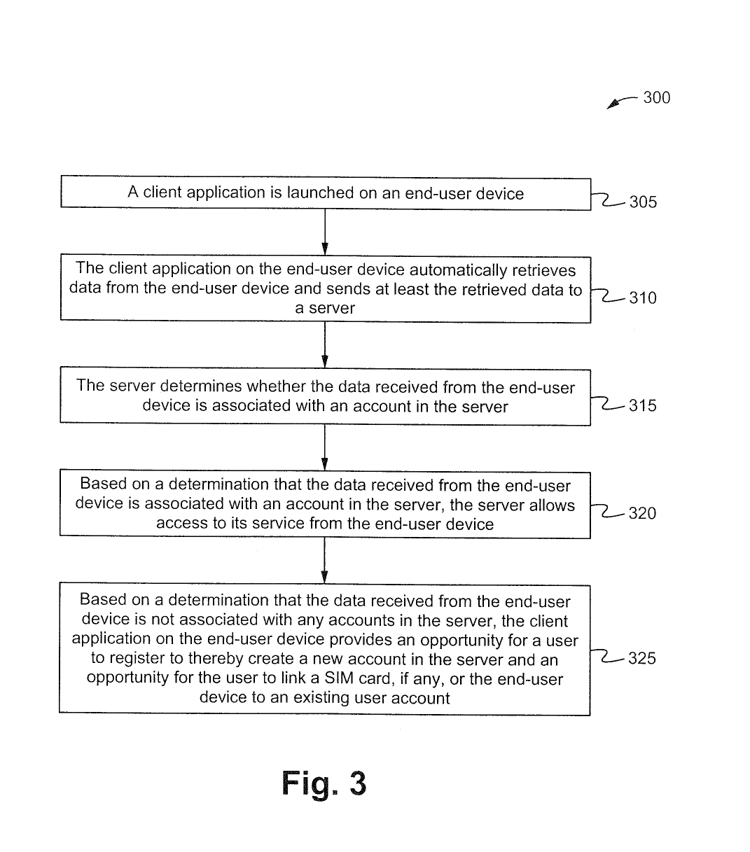

The following hypothetical illustrates user registration and controlling access of the cloud service. Assume the user owns or is otherwise in control of an end-user device that includes a client application installed thereon. The client application is configured to communicate with the server. FIG. 3 illustrates an exemplary method of dynamically controlling access to a cloud service according to some embodiments. The cloud service is provided by the server.

At a step 305, the client application is launched on the end-user device. Upon launch or execution of the client application on the end-user device, the end-user device communicatively couple with the server.

At a step 310, the client application on the end-user device automatically retrieves data from the end-user device and sends at least the retrieved data to the server. If the client application detects a SIM card in the end-user device, then the data retrieved from the end-user device includes at least the carrier-supplied unique user identifier that is stored in the SIM card. If the client application does not detect a SIM card in the end-user device, then the data retrieved from the end-user device includes at least the unique device identifier of the end-user device.

In some embodiments, the client application also sends a server-generated token, if any, with the retrieved data to the server. Server-generated tokens are discussed elsewhere. However, briefly, a server-generated token provides a third authentication factor. The token must be valid to access the cloud service from the end-user device. As such, if either an end-user device or a SIM card is compromised, the token can be invalidated to deny access to the cloud service from that end-user device. In some embodiments, the method 300 proceeds with steps 315-325 only if the token is valid. The token is stored in a memory of the end-user device or elsewhere (e.g., location remote from the end-user device) as long as the token is accessible by the end-user device.

At a step 315, the server determines whether the data received from the end-user device is associated with an account in the server.

At a step 320, based on a determination that the data received from the end-user device is associated with an account in the server, the server allows access to its cloud service from the end-user device since either the user is carrier-authenticated or the end-user device is server-authenticated (e.g., an “approved” device).

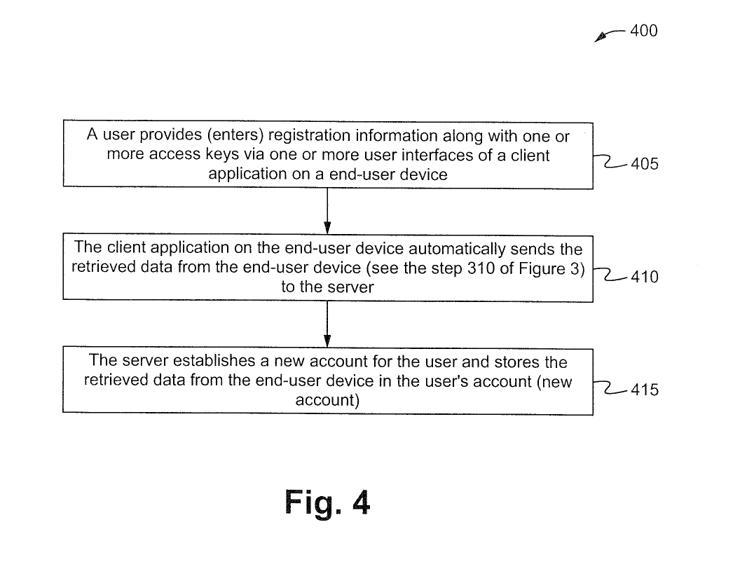

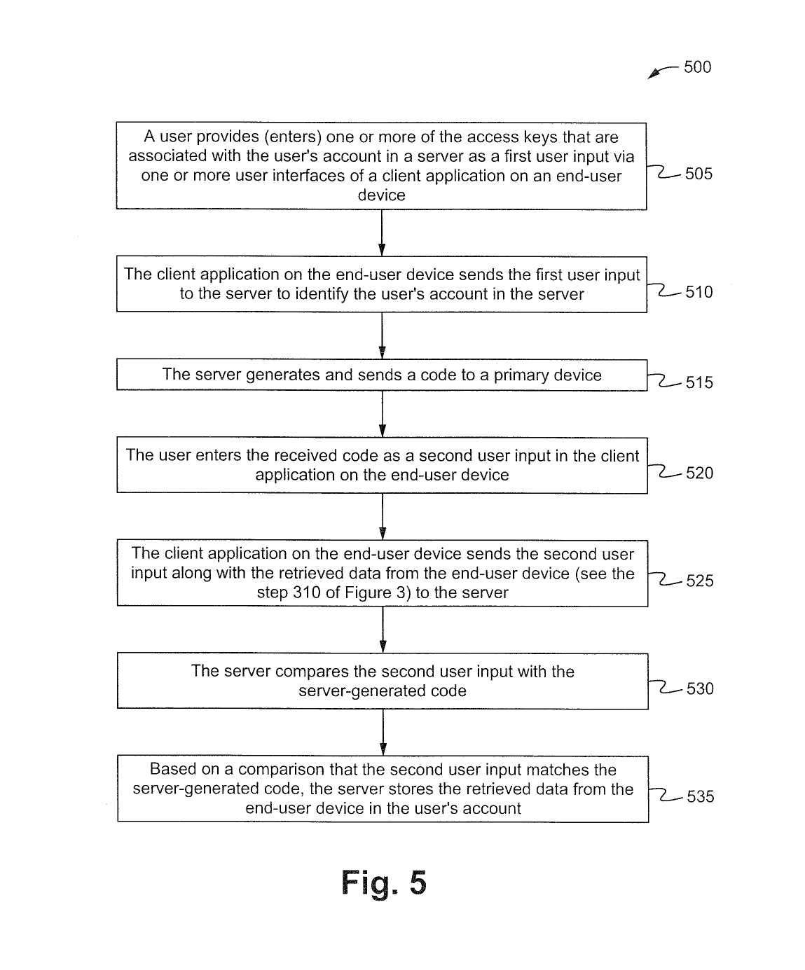

At a step 325, based on a determination that the data received from the end-user device is not associated with any accounts in the server, the client application on the end-user device provides an opportunity for the user to register to thereby create a new account in the server (as discussed in FIG. 4), and an opportunity for the user to link the SIM card, if any, or the end-user device to an existing user account (as discussed in FIG. 5).

FIG. 4 illustrates an exemplary method 400 of registering with a server in accordance with some embodiments. At a step 405, the user provides (enters) registration information, such as name, address, billing information, etc., along with one or more access keys via one or more user interfaces of the client application on the end-user device. The access keys are a form of authentication to access the user's account and/or the cloud-based content.

At a step 410, the client application on the end-user device automatically sends the retrieved data from the end-user device (see the step 310 of FIG. 3) to the server.

At a step 415, the server establishes a new account for the user and stores the retrieved data from the end-user device in the user's account. As a result, any subsequent communication with the server from the end-user device is automatically allowed because either the user is carrier-authenticated (based on the stored unique user identifier that is stored in the user's account in the server) or the end-user device is server-authenticated (based on the stored unique device identifier that is stored in the user's account in the server). In some embodiments, the end-user device used during registration is indicated as a primary device in the user's account.

FIG. 5 illustrates an exemplary method 500 of updating a user account in accordance with some embodiments. At a step 505, the user provides (enters) one or more of the access keys that are associated with the user's account in the server as a first input via one or more user interfaces of the client application on the end-user device.

At a step 510, the client application on the end-user device sends the first user input to the server as a first authentication factor to identify the user's account in the server.

At a step 515, the server generates and sends a code to a primary device indicated in the user's account via e-mail, SMS, or the like. In some embodiments, the generated code is a one-time authentication code.

At a step 520, the user enters the received code as a second user input in the client application on the end-user device.

At a step 525, the client application on the end-user device sends the second user input to the server as a second authentication factor, along with the retrieved data from the end-user device (see the step 310 of FIG. 3) to the server.

At a step 530, the server compares the second user input with the server-generated code.

At a step 535, based on a comparison that the second user input matches the server-generated code, the server stores the retrieved data from the end-user device in the user's account.

In some embodiments, prior to the server storing the retrieved data from the end-user device in the user's account, the server generates and sends a token to the end-user device. The client application automatically reads the token and presents the token along with the retrieved data to the server to be stored in the user's account. Each time the client application on the end-user device communicates with the server, the token is sent to the server as a third authentication factor. The token can be invalidated by the user, by the server or both. The token must be valid for access to the cloud service.

When a token associated with an end-user device is invalidated, that end-user device is no longer “approved” and becomes “disabled” such that the cloud service can no longer be accessed from that device until it is approved again. The user is able to disable an end-user device by logging into the user's account to select that device to be disabled. Alternatively or in addition to, the user is able to disable the device via the client application on that device. In either case, when the token for an end-user device is invalidated, the cloud service is not accessible from that device. A token can be invalidated, for example, when an associated phone or an associated SIM card is lost/compromised or when the associated phone is loaned to another user for use.

The server is configured to deny access to its cloud service due to any remote security concerns, such as an invalid token or incorrect key. Conversely, the server is configured to allow access to its cloud service upon authorization. The user is able to permanently “enable” an end-user device to work without the need to constantly reenter their username/password as long as the user is attempting access via an end-user device that matches the one listed within the server, while retaining the ability to reject or block access from a device if that device is stolen or lost. Even if the user performs a factory reset on the end-user device or uninstall and install the client application again, the end-user device remains authenticated since the server authenticates the end-user device rather than the user's account. As such, after a reinstall of the client application, the user does not need to reenter credentials to access the cloud-based content.

In some embodiments, if the user has a unique user identification that is supplied by a carrier, then the user is able to edit the account information to include the carrier authenticated user identification. This would allow the user to access the cloud-based content without the need to enter credentials as long as the user is using the same SIM card from the carrier since the carrier is providing the authentication to the server. The user is thus able to transition from one device to the next and access cloud based content without the need to identify oneself via an account, an NFC or other device pairing mechanism. In some embodiments, the carrier supplied user identification would be only required authentication.

One of ordinary skill in the art will realize other uses and advantages also exist. While the invention has been described with reference to numerous specific details, one of ordinary skill in the art will recognize that the invention can be embodied in other specific forms without departing from the spirit of the invention. Thus, one of ordinary skill in the art will understand that the invention is not to be limited by the foregoing illustrative details, but rather is to be defined by the appended claims.

We claim:

1. A method of using multiple-factor authentication for accessing a cloud service from end-user devices, comprising:
automatically retrieving by an end-user device data from the end-user device;
transmitting by the end-user device the retrieved data to a server;
determining by the server whether the retrieved data transmitted from the end-user device is associated with an account in the server;
based on a determination that the retrieved data is associated with an account in the server, allowing by the server access to its service from the end-user device; and
based on a determination that the retrieved data is not associated with any accounts in the server, providing by the end-user device an opportunity to register to thereby create a new account in the server and an opportunity to link either a SIM card or the end-user device to an existing account.

2. The method of claim 1, wherein automatically retrieving by an end-user device data from the end-user device comprises:
detecting by the end-user device whether a SIM card is associated with the end-user device;
based on a detection that a SIM card is associated with the end-user device, extracting by the end-user device a carrier-supplied unique user identifier from the SIM card, wherein the retrieved data includes the carrier-supplied unique user identifier; and
based on a detection that no SIM card is associated with the end-user device, extracting by the end-user device a unique device identifier of the end-user device, wherein the retrieved data includes the unique device identifier.

3. The method of claim 2, further comprising transmitting by the end-user device a server-generated token that is stored on the end-user device.

4. The method of claim 2, wherein providing by the end-user device an opportunity to register to thereby create a new account in the server comprises:
receiving by the end-user device registration information and at least one access key that are input by a user;
transmitting by the end-user device the retrieved data to the server;
establishing by the server the new account; and
storing the registration information and the at least one access key in the new account.

5. The method of claim 4, wherein the end-user device is indicated as a primary device in the new account.

6. The method of claim 2, wherein providing by the end-user device an opportunity to link either a SIM card or the end-user device to an existing account comprises:
receiving by the end-user device a first user input, wherein the first user input includes at least one access key associated with the existing account;
sending by the end-user device the first user input to the server to identify the existing account;
generating and sending by the server a code to a primary device that is distinct and separate from the end-user device;
receiving by the end-user device a second user input;
transmitting by the end-user device the second user input and the retrieved data to the server;
comparing by the server the second user input with the code;
based on a comparison that the second user input matches the code, storing by the server the retrieved data in the existing account.

7. The method of claim 6, wherein the code is a one-time authentication code.

8. The method of claim 7, further comprising, prior to storing by the server the retrieved data in the existing account:
generating and sending by the server a token to the end-user device;
automatically reading by the end-user device the token, transmitting by the end-user device the token to the server; and
determining by the server whether the transmitted token is valid.

9. A system for using multiple-factor authentication for accessing a cloud service from end-user devices, comprising:
a server providing a cloud service and configured to generate a one-time authentication code; and
an end-user device in communication with the server and configured to:
retrieve by the end-user device data from the primary end-user device;
send by the end-user device the retrieved data to the server;
access by the end-user the cloud service upon a first determination by the server;
create by the end-user device a new account in the server upon a second determination by the server; and
update by the end-user device an existing account in the server upon a third determination by the server.

10. The system of claim 9, wherein the end-user device includes a SIM card, and wherein the retrieved data includes a carrier-supplied unique user identifier extracted from the SIM card.

11. The system of claim 9, wherein the end-user device does not include a SIM card, and wherein the retrieved data includes a unique device identifier of the end-user device.

12. The system of claim 9, wherein the first determination by the server includes a determination that retrieved data is associated with an account in the server.

13. The system of claim 12, wherein the server is also configured to generate a token, and wherein the first determination by the server also includes a determination that a user input on the end-user device matches the token generated by the server.

14. The system of claim 12, wherein the second determination by the server includes a determination that a user of the end-user device does not have an account in the server.

15. The system of claim 14, wherein the new account in the server includes the retrieved data.

16. The system of claim 15, wherein the third determination by the server includes a determination that the user of the end-user device is associated with the existing account in the server.

17. The system of claim 16, wherein the existing account in the server includes the retrieved data.

18. The system of claim 17, wherein the third determination by the server also includes a determination that another user input on the end-user device matches the one-time authentication code generated by the server, and wherein the existing account in the server includes the retrieved data only when there is a match between the another user input and the one-time authentication code.

19. A computing device in communication with a server that provides a cloud service, comprising:
a processor; and
an application executed by the processor, the application configured to:
retrieve data from the primary end-user device;
send the retrieved data to the server;
access the cloud service upon a determination by the server that retrieved data is associated with an account in the server;
create a new account in the server with the retrieved data upon a determination by the server that a user of the computing device does not have an account in the server; and
update an existing account in the server with the retrieved data upon a determination by the server the user is associated with the existing account in the server.

20. The computing device of claim 19, wherein the data includes a carrier-supplied unique user identifier extracted from a SIM card that is coupled with the computing device or includes a unique device identifier of the computing device.
